(19) United States
(12) Patent Application Publication
(10) Pub. No.: US 2026/0070600 A1
(43) Pub. Date: Mar. 12, 2026

(54) STEERING APPARATUS

(71) Applicant: Honda Motor Co., Ltd., Tokyo (JP)

(72) Inventor: Shotaro Odate, Tokyo (JP)

(21) Appl. No.: 19/321,816

(22) Filed: Sep. 8, 2025

(30) Foreign Application Priority Data
Sep. 10, 2024 (JP) 2024-155496

(51) Int. Cl. B62D 1/06; B60K 35/21; B62D 1/04; B62D 1/10

(52) U.S. Cl. CPC B62D 1/06; B60K 35/21; B62D 1/046; B62D 1/10

(57) ABSTRACT

The steering apparatus includes a sensor unit having sensors configured to detect contact or proximity of a human body in a plurality of detection target regions provided on a steering wheel, and a microprocessor. The microprocessor is configured to perform a determination of whether or not the steering wheel is being gripped by comparing output values of the sensor unit with a determination threshold value. The electrodes of the sensors include a pair of electrodes arranged such that their detection target regions overlap each other and have different surface areas. The microprocessor is configured to calculate a moving average of the detection value of each of the pair of electrodes, and further compare a total value of the moving averages of the pair of electrodes with the determination threshold value as the output value of the sensor unit.

### CROSS-REFERENCE TO RELATED APPLICATION

This application is based upon and claims the benefit of priority from Japanese Patent Application No. 2024-155496 filed on Sep. 10, 2024, the content of which is incorporated herein by reference.

### BACKGROUND OF THE INVENTION

### Field of the Invention

The present invention relates to a steering apparatus having a function for detecting whether a driver is gripping a steering wheel.

### Description of the Related Art

In recent years, efforts to provide access to sustainable transportation systems that take into account people in vulnerable positions among traffic participants have been gaining momentum. In order to achieve this, research and development have been focused on further improving traffic safety and convenience through the research and development regarding driving assistance technologies. In the related art, there has been known a device that determines whether or not a human body is in contact with a steering wheel by comparing a detection value of a capacitive sensor provided on the steering wheel with a threshold value (for example, refer to JP 2019-023012 A). In the device disclosed in JP 2019-023012 A, a correction value is calculated on the basis of a moving average value of a predetermined number of most recent detection values including the current detection value, and the current detection value is corrected using the correction value so as to suppress a decrease in detection accuracy due to degradation of the capacitive sensor or the like.

However, merely correcting the detection value using the correction value, as in the device described in JP 2019-023012 A, may result in a decrease in detection accuracy in a case where an environmental change (for example, in humidity) occurs.

### SUMMARY OF THE INVENTION

An aspect of the present invention is a steering apparatus including: a sensor unit including a plurality of sensors configured to detect contact or proximity of a human body in a plurality of detection target regions provided on a steering wheel; and a microprocessor. The microprocessor is configured to perform: comparing output values of the sensor unit with a determination threshold value; and determining whether or not the steering wheel is being gripped, based on a result of the comparing. The plurality of sensors include a plurality of electrodes, the plurality of electrodes include a pair of electrodes arranged such that the detection target regions thereof overlap each other and have different surface areas. The microprocessor is configured to perform the determining including calculating a moving average of a detection value of each of the pair of electrodes according to a predetermined number of terms for each of the pair of electrodes, and further comparing a total value of the moving averages of the pair of electrodes with the determination threshold value as the output value of the sensor unit.

### BRIEF DESCRIPTION OF THE DRAWINGS

The objects, features, and advantages of the present invention will become clearer from the following description of embodiments in relation to the attached drawings, in which:

FIG. 1A is a front view of a steering wheel to which a steering apparatus according to an embodiment of the present invention is applied;

FIG. 1B is a diagram illustrating an example of electrodes embedded in the spoke portion in FIG. 1A;

FIG. 2A is a diagram illustrating an example of an electrode unit including the electrodes;

FIG. 2B is a perspective view of the hub portion of the steering wheel in FIG. 1A;

FIG. 3 is a block diagram illustrating a configuration of a main part of the steering apparatus according to the present embodiment;

FIG. 4 is a diagram illustrating a state where a beverage is spilled on the steering wheel in FIG. 1A;

FIG. 5 is a diagram illustrating an example of a configuration of a driving assistance system including the steering apparatus in FIG. 3; and

FIG. 6 is a flowchart illustrating an example of processing to be executed by a CPU of the controller in FIG. 3.

### DETAILED DESCRIPTION OF THE INVENTION

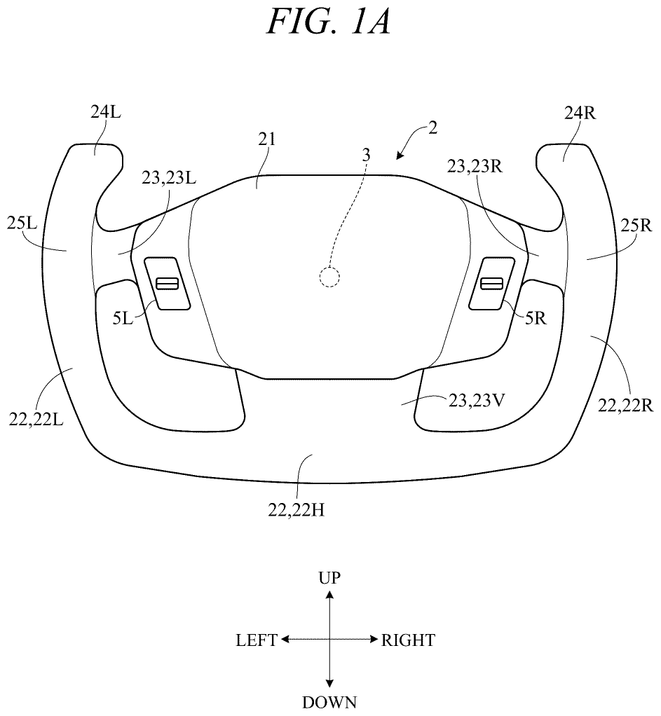

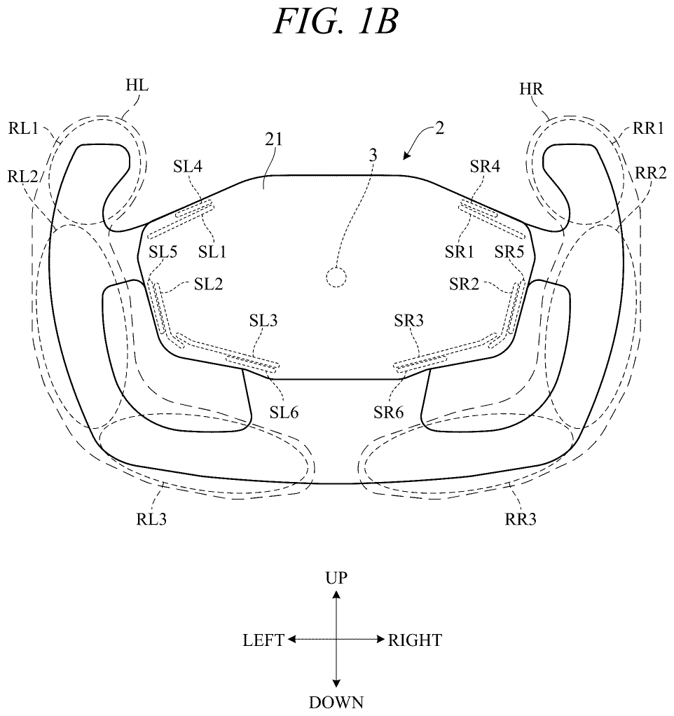

Hereinafter, embodiments of the invention will be described with reference to the drawings. FIG. 1A is a front view of a steering wheel to which a steering apparatus according to an embodiment of the present invention is applied. The steering apparatus according to an embodiment of the present invention is applicable to a manually driven vehicle including a driving assistance system such as advanced driver-assistance systems (ADAS). Note that a vehicle to which the steering apparatus according to the present embodiment is applied will be referred to as a subject vehicle in some cases so as to be distinguished from other vehicles. A steering wheel 2 in FIG. 1A is operated by a driver on a driver's seat of the subject vehicle. A steering shaft 3, which pivotally supports the steering wheel 2, is coupled to the back side of the steering wheel 2 in a front view (as viewed from the driver).

For convenience of description, two orthogonal axial directions as illustrated in the drawing are defined as a left-right direction and an up-down direction. In addition, the front side of the steering wheel 2 is defined as the front, and the back side thereof is defined as the rear, thereby defining a front-rear direction. Hereinafter, the configuration of each unit will be described in accordance with these definitions. The left-right direction corresponds to a left-right direction of the vehicle. The up-down direction corresponds to an up-down direction of the steering wheel 2 as viewed from the front. Note that the up-down direction and the front-rear direction do not necessarily coincide with the up-down direction and the front-rear direction of the vehicle.

As illustrated in FIG. 1A, the steering wheel 2 is an irregularly shaped steering wheel, and includes a hub portion 21, a rim portion (grip portion) 22, and a spoke portion 23 that connects the hub portion 21 and the rim portion 22. The rim portion 22 includes a pair of left and right rim portions (vertical portions) 22L and 22R that extend substantially in the up-down direction on the left and right sides of the hub portion 21, and a horizontal portion 22H that extends substantially in the left-right direction below the hub portion 21 and connects the rim portions (vertical portions) 22L and 22R to each other. The spoke portion 23 includes horizontal portions 23L and 23R that connect the hub portion 21 to the rim portions (vertical portions) 22L and 22R, and a perpendicular portion 23V that connects the hub portion 21 to the horizontal portion 22H. The rim portion (vertical portion) 22L is provided such that an end portion 24L thereof protrudes upward from a connection portion 25L between the spoke portion (horizontal portion) 23L and the rim portion (vertical portion) 22L. Similarly, the rim portion (vertical portion) 22R is provided such that an end portion 24R thereof protrudes upward from a connection portion 25R between the spoke portion (horizontal portion) 23R and the rim portion (vertical portion) 22R.

As illustrated in FIG. 1A, the spoke portions 23L and 23R are respectively provided with operation console units (hereinafter, referred to as functional switch units) 5L and 5R for allowing the driver to operate vehicle auxiliary devices (not illustrated) (a navigation unit, an audio device, an air conditioning device, and the like), as well as ADAS functions. The driver can operate the vehicle auxiliary devices and the like by operating a plurality of switches provided on the operation console units 5L and 5R with their fingers.

FIG. 1B illustrates an example of electrodes of the capacitive sensor embedded in the spoke portion. Note that, for clarity of the drawing, the operation console units 5L and 5R are omitted in FIG. 1B. The hub portion 21 incorporates electrodes SL1 to SL6 and SR1 to SR6, which are formed in a plate shape and have conductivity. The electrodes SL1 to SL6 are provided in the vicinity of a recommended grip region HL for the left hand, which is defined with respect to the rim portion 22 in the steering wheel 2. As illustrated in FIG. 1B, the electrodes SL1 and SL4 are provided along a side wall surface on the upper left side of the hub portion 21. The electrodes SL2 and SL5 are provided along a side wall surface on the left side of the hub portion 21. The electrodes SL3 and SL6 are provided along a side wall surface on the lower left side of the hub portion 21. A region RL1 represents a detection target region of the electrodes SL1 and SL4. A region RL2 represents a detection target region of the electrodes SL2 and SL5. A region RL3 represents a detection target region of the electrodes SL3 and SL6. As illustrated in FIG. 1B, the electrodes SL1 to SL6 are arranged such that the detection target regions RL1 to RL3 cover the entire recommended grip region HL.

The electrodes SR1 to SR6 are provided in the vicinity of a recommended grip region HR for the right hand, which is defined with respect to the rim portion 22 in the steering wheel 2. As illustrated in FIG. 1B, the electrodes SR1 and SR4 are provided along a side wall surface on the upper right side of the hub portion 21. The electrodes SR2 and SR5 are provided along a side wall surface on the right side of the hub portion 21. The electrodes SR3 and SR6 are provided along a side wall surface on the lower right side of the hub portion 21. A region RR1 represents a detection target region of the electrodes SR1 and SR4. A region RR2 represents a detection target region of the electrodes SR2 and SR5. A region RR3 represents a detection target region of the electrodes SR3 and SR6. As illustrated in FIG. 1B, the electrodes SR1 to SR6 are arranged such that the detection target regions RR1 to RR3 cover the entire recommended grip region HR.

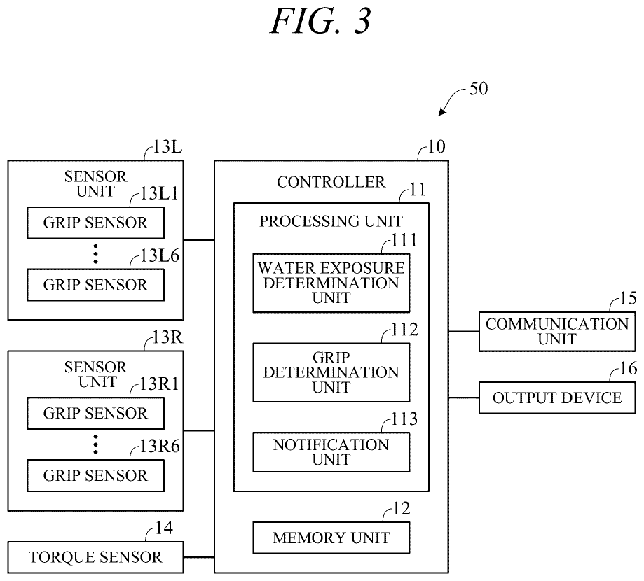

The electrodes SL1 to SL6 and SR1 to SR6 are respectively connected to grip sensors (hereinafter, sometimes simply referred to as sensors) 13L1 to 13L6 and 13R1 to 13R6 of sensor units 13L and 13R in FIG. 3 to be described later, via signal lines (not illustrated).

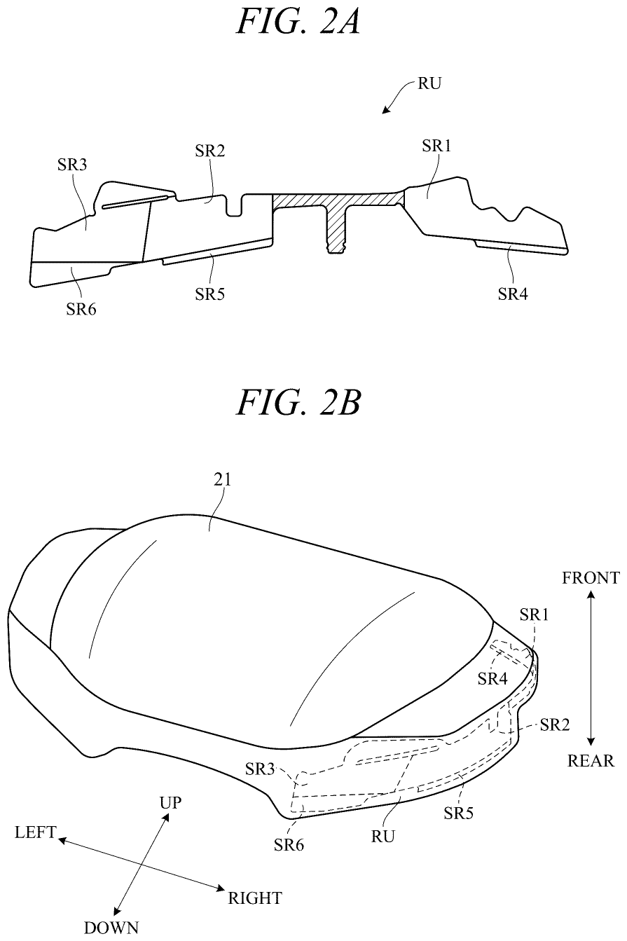

Here, the electrodes SL1 to SL6 and SR1 to SR6 will be described in detail with reference to FIGS. 2A and 2B. FIG. 2A is a diagram illustrating an example of an electrode unit RU including the electrodes SR1 to SR6. A region hatched in FIG. 2A is a joint portion between the electrodes SR1 and SR2, and also functions as an attachment portion for fixing the electrode unit RU to the hub portion 21. Note that an electrode unit LU (not shown) including the electrodes SL1 to SL6 is similar to the electrode unit RU in FIG. 2A, and thus only the configuration of the electrode unit RU will be described below. FIG. 2B is a perspective view of the hub portion 21 of the steering wheel 2. In FIG. 2B, the electrode unit RU embedded in the hub portion 21 is indicated by dashed lines. Note that, for clarity of the drawing, the operation console units 5L and 5R are omitted in FIG. 2B. In addition, in FIG. 2B, the electrode unit LU embedded on the left side of the hub portion 21 is also omitted.

The electrodes SR4, SR5, and SR6 are arranged such that their detection ranges (detection target regions) are substantially the same as those of the electrodes SR1, SR2, and SR3, respectively. Specifically, as illustrated in FIGS. 2A and 2B, the electrodes SR4, SR5, and SR6 are arranged adjacent to the electrodes SR1, SR2, and SR3, respectively, such that in a state where the electrodes SR4, SR5, and SR6 are embedded in the hub portion 21, the distances from the rim portion 22 of the steering wheel 2 are substantially the same as those of the electrodes SR1, SR2, and SR3. Hereinafter, the positional relationship between the electrodes SR1, SR2, and SR3 and the electrodes SR4, SR5, and SR6, as illustrated in FIG. 2A, is referred to as a paired arrangement.

FIG. 3 is a block diagram illustrating a configuration of a main part of the steering apparatus according to the present embodiment. As illustrated in FIG. 3, a steering apparatus 50 includes a controller 10, the sensor units 13L and 13R, a steering torque sensor (hereinafter, simply referred to as a torque sensor) 14, a communication unit 15, and an output device 16. The communication unit 15 connects the steering apparatus 50 to a communication network (network) such as a controller area network (CAN). The steering apparatus 50 is capable of performing communication with an in-vehicle device (not illustrated) via the communication unit 15 through CAN communication or the like. Note that the steering apparatus 50 may be capable of performing communication with an in-vehicle device or an external device (not illustrated) via a wireless communication network.

The sensor unit 13L includes the grip sensors 13L1 to 13L6 respectively connected to the electrodes SL1 to SL6 in FIG. 1B via signal lines (not illustrated). The sensor unit 13R includes the grip sensors 13R1 to 13R6 respectively connected to the electrodes SR1 to SR6 in FIG. 1B via signal lines (not illustrated). The grip sensors 13L1 to 13L6 and 13R1 to 13R6 detect electrical characteristics (for example, capacitance between the electrode and ground (for example, vehicle body)) of the electrodes SL1 to SL6 and SR1 to SR6, respectively.

The torque sensor 14 detects torque, that is, the steering torque around the rotation axis of the steering wheel 2 input by the driver.

The output device 16 is a generic term for devices that output information to the driver. The output device 16 includes a display that provides the driver with information via a display image, a speaker that provides the driver with information by sound, and the like.

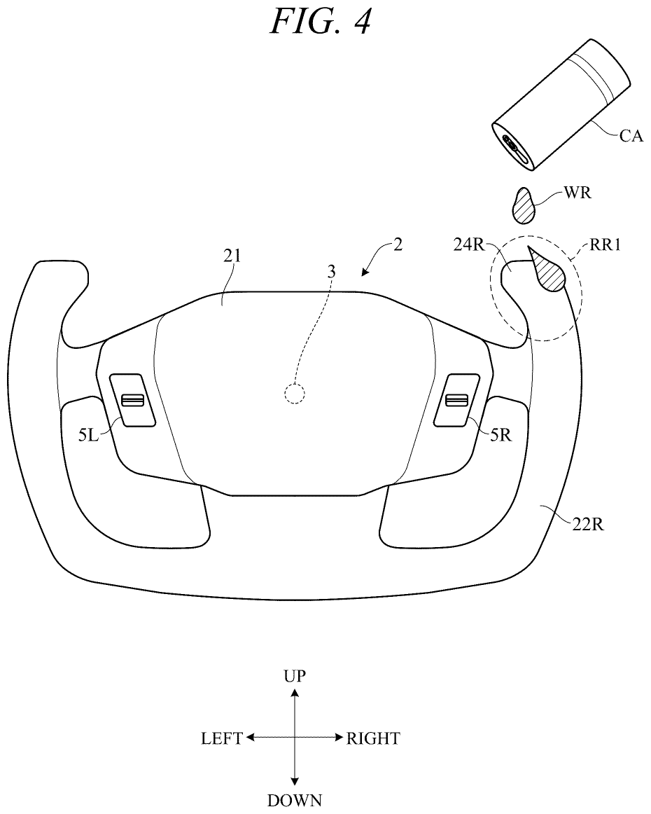

Incidentally, the capacitive sensors such as the grip sensors 13L1 to 13L6 and 13R1 to 13R6 have a characteristic in which the detection sensitivity is increased due to water or moisture. FIG. 4 is a diagram illustrating a state where a beverage is spilled on the steering wheel 2. FIG. 4 illustrates a state where a beverage WR is spilled from a container (can) CA on the end portion 24R. Hereinafter, as illustrated in FIG. 4, wetting of the steering wheel 2 due to application of a liquid such as water is expressed as the steering wheel 2 being exposed to water.

In a case where the steering wheel 2 is exposed to water, the electrodes corresponding to the water-exposed region exhibit increased detection sensitivity due to the above-described characteristic. In the example in FIG. 4, the detection sensitivity of the electrodes SR1 and SR4, which correspond to the water-exposed region RR1, is increased. Therefore, in a case where the steering wheel 2 is exposed to water when determining the grip of the steering wheel 2 on the basis of the magnitude of the output value (capacitance of the electrodes) of the capacitive sensor, there is a risk of erroneously determining that the steering wheel 2 is being gripped even though the steering wheel 2 is not actually being gripped. In addition, in a case where the electrode of the capacitive sensor itself is exposed to water, a normal output value can no longer be obtained from the capacitive sensor, and thus the grip determination for the steering wheel 2 cannot be executed. Therefore, in order to handle such an issue, the controller 10 of the steering apparatus 50 is configured as follows in the present embodiment.

The controller 10 includes a processing unit 11 such as a CPU (microprocessor) and a memory unit 12. The processing unit 11 includes a water exposure determination unit 111, a grip determination unit 112, and a notification unit 113, as functional configurations. The memory unit 12 stores programs for various kinds of control and information such as threshold values used in the programs.

The water exposure determination unit 111 determines the presence or absence of the water exposure to the electrodes SL1 to SL6 and SR1 to SR6, on the basis of the output values of the grip sensors of the sensor units 13L and 13R.

In capacitive sensors, the smaller the electrode area (surface area of the electrode), the greater the ratio of moisture amount to electrode area, and therefore, electrodes with smaller surface areas are more susceptible to the effects of water exposure. Accordingly, the water exposure determination unit 111 determines the presence or absence of the water exposure to the electrode unit LU by monitoring the capacitance of the electrodes SL4, SL5, and SL6 with small surface area.

Specifically, when the output value of any of the grip sensors 13L4 to 13L6, included in the output values of the sensor unit 13L, is equal to or greater than a predetermined value PC, the water exposure determination unit 111 determines that the electrode corresponding to the grip sensor is exposed to water. The predetermined value PC may be set to a value that indicates an abnormality (detection error) of the grip sensor, or may be set to another value.

In addition, the water exposure determination unit 111 determines the presence or absence of the water exposure to the electrode unit RU by monitoring the capacitance of the electrodes SR4, SR5, and SR6 with small surface area. Note that the determination of the presence or absence of water exposure to the electrode unit RU is similar to the determination of the presence or absence of water exposure to the electrode unit LU.

Note that in a case where the electrodes SL4, SL5, and SL6 are exposed to water, it is assumed that the electrodes SL1, SL2, and SL3, which are arranged to face the electrodes SL4, SL5, and SL6, are also exposed to water. Similarly, in a case where the electrodes SR4, SR5, and SR6 are exposed to water, it is assumed that the electrodes SR1, SR2, and SR3 which are arranged to face the electrodes SR4, SR5, and SR6, are also exposed to water. Therefore, when the output value of any grip sensor of the grip sensors 13L4 to 13L6 and 13R4 to 13R6 is equal to or greater than the predetermined value PC, the water exposure determination unit 111 determines that both the electrode corresponding to that grip sensor and the electrode arranged to face that electrode are exposed to water.

The grip determination unit 112 detects the presence or absence of contact of a human body with the detection target regions RL1 to RL3 and RR1 to RR3 on the basis of whether the output values of the sensor units 13L and 13R are equal to or greater than a determination threshold value C_Th. When the contact of a human body with any detection target region of the detection target regions RL1 to RL3 and RR1 to RR3 is detected, the grip determination unit 112 determines that the steering wheel 2 is being gripped by the driver.

Since the capacitive sensor can store a larger amount of capacitance as the electrode area is increased, the larger the electrode area, the greater the variation in output value in response to changes in humidity, moisture, or the like. Such a variation in output value may reduce the accuracy of grip determination performed by the grip determination unit 112. Thus, the grip determination unit 112 calculates the output values of the sensor units 13L and 13R, which are used for comparison with the determination threshold value C_Th, in the following manner.

First, the grip determination unit 112 calculates moving averages ma_l1 and ma_l4 of the respective output values of the pair of electrodes SL1 and SL4, on the basis of a predetermined number of terms set for each of the electrodes SL1 and SL4. Note that the number of terms for the moving average is determined on the basis of the electrode area. Specifically, the number of terms for the moving average is set to be increased as the electrode has a larger surface area. Similarly, the grip determination unit 112 calculates moving averages ma_l2 and ma_l5 of the respective output values of the pair of electrodes SL2 and SL5, and moving averages ma_l3 and ma_l6 of the respective output values of the pair of electrodes SL3 and SL6.

Next, the grip determination unit 112 calculates each of a total value sm_l1 of the moving averages ma_l1 and ma_l4, a total value sm_l2 of the moving averages ma_l2 and ma_l5, and a total value sm_l3 of the moving averages ma_l3 and ma_l6. The grip determination unit 112 acquires the total values sm_l1, sm_l2, and sm_l3 as the output values of the sensor unit 13L.

The grip determination unit 112 compares the output values of the sensor unit 13L acquired in this manner, with the determination threshold value C_Th to detect the presence or absence of contact of a human body with the detection target regions RL1 to RL3, that is, contact of a human body with the recommended grip region HL. When the total value sm_l1 is equal to or greater than the determination threshold value C_Th, contact of a human body with the detection target region RL1 is detected. Similarly, when the total value sm_l2 is equal to or greater than the determination threshold value C_Th, contact of a human body with the detection target region RL2 is detected, and when the total value sm_l3 is equal to or greater than the determination threshold value C_Th, contact of a human body with the detection target region RL3 is detected.

Similarly, the grip determination unit 112 detects the presence or absence of contact of a human body with the detection target regions RR1 to RR3, that is, contact of a human body with the recommended grip region HR. When the contact of a human body with any of the recommended grip regions HL and HR is detected, the grip determination unit 112 determines that the steering wheel 2 is being gripped by the driver.

Note that, in a case where the approach of a human body to the recommended grip regions HL and HR (an approaching motion within a predetermined distance) is detected, it can be determined that the driver can immediately grip the steering wheel 2. Therefore, even in a case where the approach of a human body to any of the recommended grip regions HL and HR is detected, the grip determination unit 112 may determine that the steering wheel 2 is being gripped by the driver. That is, when the contact or approach of a human body with respect to any of the recommended grip regions HL and HR is detected, the grip determination unit 112 may determine that the steering wheel 2 is being gripped by the driver. Note that in a case where the contact or approach with respect to the recommended grip regions HL and HR is detected, the determination threshold value C_Th is set to a smaller value than in a case where only the contact with the recommended grip regions HL and HR is detected.

The notification unit 113 generates information (hereinafter, referred to as grip state information) indicating a grip state on the basis of determination results of the water exposure determination unit 111 and the grip determination unit 112. In a case where the grip determination unit 112 determines that the steering wheel 2 is being gripped, the notification unit 113 generates grip state information indicating “grip (normal)” as the grip state. In addition, in a case where the grip determination unit 112 determines that the steering wheel 2 is not being gripped, the notification unit 113 generates grip state information indicating “non-grip” as the grip state. Furthermore, when the water exposure determination unit 111 determines that the electrode of any grip sensor of the grip sensors 13L4 to 13L6 and 13R4 to 13R6 is exposed to water, the notification unit 113 generates grip state information indicating “grip undeterminable” as the grip state. The notification unit 113 outputs the generated grip state information to the output device 16 mounted in the subject vehicle.

Note that when generating the grip state information indicating “non-grip”, the notification unit 113 may include warning information for prompting the driver to grip the steering wheel 2, in the grip state information. The warning information may include display information or audio information output via a display or speaker, as well as a signal for turning on or blinking a warning light or the like provided on the steering wheel 2 or in the vicinity (instrument panel or the like) of the steering wheel 2. In addition, the notification unit 113 may output the grip state information to the in-vehicle device or the external device via the communication unit 15.

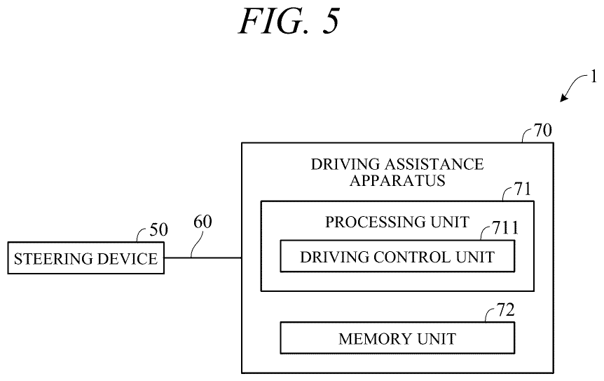

FIG. 5 is a diagram illustrating an example of a configuration of a driving assistance system 1 including the steering apparatus 50 according to the present embodiment. As illustrated in FIG. 5, the driving assistance system 1 includes the steering apparatus 50 and a driving assistance apparatus 70 that is one of in-vehicle devices. The steering apparatus 50 is communicably connected to the driving assistance apparatus 70 through a CAN bus 60.

The driving assistance apparatus 70 includes an electronic control unit (ECU). The driving assistance apparatus 70 includes a processing unit 71 such as a CPU (microprocessor) and a memory unit 72. The processing unit 71 includes a driving control unit 711 as a functional configuration. The memory unit 72 stores programs for various kinds of control and information such as threshold values used in the programs. The driving control unit 711 controls an actuator for driving (not illustrated) on the basis of information (camera image or the like) obtained from an in-vehicle sensor. The actuator for driving includes a throttle actuator that adjusts the opening degree (throttle opening degree) of a throttle valve of an engine, a brake actuator that actuates a braking device of the subject vehicle, a steering actuator that drives a steering apparatus, and the like.

The driving assistance apparatus 70 has various driving assistance functions such as LKAS and adaptive cruise control (ACC). When the LKAS is effective, the driving control unit 711 recognizes a division line that defines the current lane on the basis of the information obtained from the in-vehicle sensor, and controls the steering actuator such that the subject vehicle travels near the center of the current lane.

In this case, the driving control unit 711 acquires the grip state information output from the notification unit 113 of the steering apparatus 50 through the CAN bus 60, and recognizes the grip state of the steering wheel 2 on the basis of the grip state information. When the driver's non-grip on the steering wheel 2 is recognized, the driving control unit 711 temporarily stops the driving assistance (steering assistance) by the LKAS. When the state of the driver's non-grip continues for a predetermined time, the driving control unit 711 cancels the steering assistance. When the driver's grip on the steering wheel 2 is recognized before the state of the driver's non-grip continues for a predetermined time, the temporarily stopped steering assistance is restarted. In this manner, the grip state information output from the steering apparatus 50 is used for controlling temporary stop, restart, cancellation, or the like of the driving assistance function in the driving assistance apparatus 70.

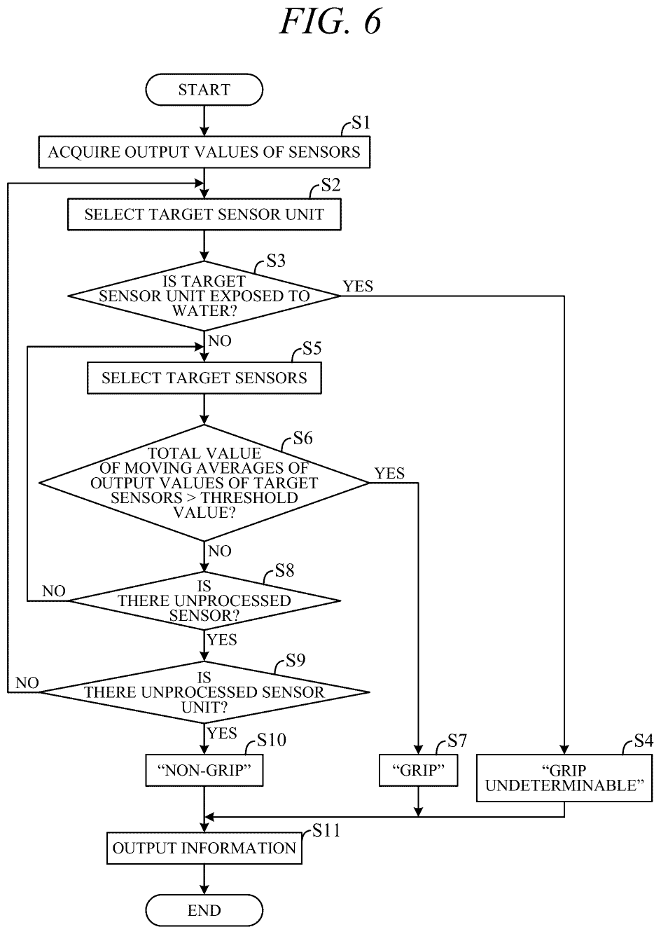

FIG. 6 is a flowchart illustrating an example of processing to be executed by the CPU of the controller 10 in FIG. 3 in accordance with a predetermined program. The processing illustrated in the flowchart is executed at a predetermined cycle while the subject vehicle is traveling, for example.

First, in step S1, the controller 10 acquires the output value of each of the grip sensors 13L1 to 13L6 and 13R1 to 13R6. The acquired output values are stored in the memory unit 12 for a certain period.

In step S2, the controller 10 selects a sensor unit (hereinafter, referred to as a target sensor unit) as a processing target. Once the target sensor unit is selected, in step S3, the controller 10 determines whether or not an electrode of a grip sensor included in the target sensor unit is exposed to water.

In a case where the sensor unit 13L is selected as the target sensor unit, the controller 10 compares the output values of the grip sensors 13L4 to 13L6 with the predetermined value PC. When the output value of any of the grip sensors 13L4 to 13L6 is equal to or greater than the predetermined value PC, the controller 10 determines that the electrode corresponding to that grip sensor and the electrode arranged to face that electrode are exposed to water. For example, in a case where the output value of the grip sensor 13L5 is equal to or greater than the predetermined value PC, it is determined that the electrodes SL2 and SL5 are exposed to water.

On the other hand, in a case where the sensor unit 13R is selected as the target sensor unit, the controller 10 compares the output values of the grip sensors 13R4 to 13R6 with the predetermined value PC. When the output value of any of the grip sensors 13R4 to 13R6 is equal to or greater than the predetermined value PC, the controller 10 determines that the electrode corresponding to that grip sensor and the electrode arranged to face that electrode are exposed to water. For example, in a case where the output value of the grip sensor 13R4 is equal to or greater than the predetermined value PC, it is determined that the electrodes SR1 and SR4 are exposed to water.

When the determination in step S3 is affirmative, that is, when it is determined that an electrode of a grip sensor included in the target sensor unit is exposed to water, the controller 10 generates grip state information indicating “grip undeterminable” in step S4.

On the other hand, when the determination in step S3 is negative, the controller 10 selects a pair of sensors (hereinafter, referred to as target sensors) as the processing target from among the grip sensors included in the target sensor unit in step S5.

In step S6, the controller 10 calculates the moving averages of the output values of the pair of sensors selected as the target sensors, and determines whether the total value of the moving averages is equal to or greater than the determination threshold value C_Th. For example, in a case where the grip sensors 13L1 and 13L4 of the sensor unit 13L are selected as the target sensors, the controller 10 calculates the moving averages ma_l1 and ma_l4 of the output values of the grip sensors 13L1 and 13L4. The moving average ma_l1 is the average of the most recent n output values of the grip sensor 13L1, including the current output value. The moving average ma_l4 is the average of the most recent m (<n) output values of the grip sensor 13L4, including the current output value. As described above, the number of terms n is determined on the basis of the size of the surface area of the electrode SL1 of the grip sensor 13L1. The number of terms m is determined on the basis of the size of the surface area of the electrode SL4 of the grip sensor 13L4. After the moving averages ma_l1 and ma_l4 are calculated, the controller 10 determines whether the total value sm_l1 thereof is equal to or greater than the determination threshold value C_Th.

When the determination in step S6 is affirmative, the controller 10 determines in step S7 that the steering wheel 2 is being gripped by the driver, and generates grip state information indicating “grip (normal)”. On the other hand, when the determination in step S6 is negative, the controller 10 determines in step S8 whether or not processing (processing in step S6) has been performed for all sensors (pairs of sensors) included in the target sensor unit.

When the determination in step S8 is affirmative, the controller 10 determines in step S9 whether or not processing (grip determination) has been performed for all sensor units. On the other hand, when the determination in step S8 is negative, that is, when there is an unprocessed sensor among the grip sensors included in the target sensor unit, the processing returns to step S5, and the controller 10 selects another pair of sensors as the processing target from among the unprocessed sensors, and repeats the processing in step S6.

When the determination in step S9 is negative, that is, when there is an unprocessed sensor unit, the processing returns to step S2, a sensor unit as the processing target is selected from among the unprocessed sensor units, and the processing in steps S3 to S8 is repeated.

On the other hand, when the determination in step S9 is affirmative, the controller 10 determines in step S10 that the steering wheel 2 is not being gripped by the driver, and generates grip state information indicating “non-grip”. Finally, in step S11, the controller 10 outputs the grip state information generated in step S4, S7, or S10 to the output device 16, and ends the processing.

Note that, in step S2, the controller 10 selects the target sensor unit in the order of the sensor unit 13L and the sensor unit 13R. However, the order of selection of the target sensor unit is not limited thereto.

In addition, in a case where the sensor unit 13L is selected as the target sensor unit, the controller 10 selects the target sensors in step S5 in the order of the grip sensors 13L1 and 13L4, the grip sensors 13L2 and 13L5, and the grip sensors 13L3 and 13L6. On the other hand, in a case where the sensor unit 13R is selected as the target sensor unit, the controller 10 selects the target sensors in step S5 in the order of the grip sensors 13R1 and 13R4, the grip sensors 13R2 and 13R5, and the grip sensors 13R3 and 13R6. However, the order of selection of the target sensor is not limited thereto.

According to the above-described embodiment, the following effects can be achieved.
(1) The steering apparatus 50 includes the sensor units 13L and 13R including the grip sensors 13L1 to 13L6 and 13R1 to 13R6 which detect the contact or approach of a human body with respect to the plurality of detection target regions RL1 to RL3 and RR1 to RR3 provided in the steering wheel 2; and the grip determination unit 112 that determines whether or not the steering wheel 2 is being gripped by comparing the output values of the sensor units 13L and 13R with the determination threshold value C_Th. The grip sensors 13L1 to 13L6 and 13R1 to 13R6 include the electrodes SL1 to SL6 and SR1 to SR6. The electrodes SL1 to SL6 and SR1 to SR6 include a pair of electrodes (for example, the electrode SL1 and the electrode SL4) that are arranged such that detection target regions overlap each other and have different surface areas. The grip determination unit 112 calculates the moving average (for example, moving average ma_l1 and moving average ma_l4) of the detection values (capacitance) of each electrode of the pair of electrodes according to a predetermined number of terms (for example, number of terms n and number of terms m (<n)) for each electrode of the pair of electrodes, and compares the total value (for example, total value sm_l1 (=ma_l1+ma_l4)) of the moving averages of the pair of electrodes with the determination threshold value C_Th as the output values of the sensor units 13L and 13R. Note that the electrodes SL1 to SL6 and SR1 to SR6 include a plurality of pairs of electrodes having different detection target regions, and the grip determination unit 112 calculates the total value of the moving averages for each electrode of the pair of electrodes, and determines that the steering wheel 2 is being gripped when the total value of the moving averages for any pair of electrodes among the plurality of pairs of electrodes is equal to or greater than the determination threshold value C_Th.

In this manner, by configuring the sensor electrodes corresponding to each of the plurality of detection target regions arranged on the steering wheel 2 as pairs of electrodes having different sizes of the surface areas, it becomes possible to perform robust grip determination against a change in environment such as humidity. In addition, by smoothing the output values of the sensors using moving averages, erroneous determinations caused by the environmental change can be suppressed, and thus robustness against the environmental change can be improved.
(2) The grip determination unit 112 calculates the moving average of the detection values of each electrode of the pair of electrodes according to a predetermined number of terms on the basis of the surface area of each electrode of the pair of electrodes. More specifically, the grip determination unit 112 determines the number of terms for the moving average of each electrode of the pair of electrodes such that the larger the surface area of the electrode, the greater the number of terms for the moving average. The variation in output value due to the environmental changes is increased as the surface area of the electrode is increased, but by determining the number of terms (number of samples) for the moving average according to the surface area of the electrode as described above, it is possible to perform the grip determination accurately regardless of the size of the surface area of the electrode. On the other hand, the number of samples can be reduced for electrodes with small surface areas, which are less affected by environmental changes, and thus computational load can be reduced.
(3) The pair of electrodes includes a first electrode and a second electrode that has a smaller surface area than the first electrode, and the first electrode and the second electrode are arranged adjacent to each other such that the distances from the rim portion 22 of the steering wheel 2 are substantially the same. The steering apparatus 50 further includes the water exposure determination unit 111 that determines that the second electrode or the pair of electrodes is exposed to water when the detection value of the second electrode having the smaller surface area in the pair of electrodes is equal to or greater than the predetermined value PC. As a result, it is possible to perform early detection of water ingress or condensation on the pair of electrodes by using the second electrode with a small surface area, while detecting environmental changes (changes in humidity) using the first electrode with a large surface area. As described above, by utilizing the characteristics of each of the electrodes having different surface areas, a more appropriate grip determination can be achieved.
(4) The steering apparatus 50 further includes the output device 16 that outputs information, and the notification unit 113 that notifies the driver, via the output device 16, of information generated on the basis of the determination results by the water exposure determination unit 111 and the grip determination unit 112. This enables the driver to recognize the result of the grip determination. In addition, the result of the grip determination can be used for the driving assistance function such as the LKAS. As a result, the safety while operating the steering wheel can be improved.
(5) The steering wheel 2 includes the hub portion 21; the rim portion (grip portion) 22 having the pair of left and right vertical portions 22L and 22R that extend in a substantially up-down direction on the left and right sides of the hub portion 21, and the horizontal portion 22H that extends substantially in the left-right direction below the hub portion 21 and connects the pair of left and right vertical portions 22L and 22R to each other; and the spoke portions 23L and 23R that connect the pair of left and right vertical portions 22L and 22R to the hub portion 21. The sensor units 13L and 13R (more specifically, the electrodes of the grip sensors included in the sensor units 13L and 13R) are arranged in the vicinity of functional switch units 5L and 5R, which are respectively disposed on the left and right portions of the hub portion 21 and are used for the vehicle information operation or the driving assistance function operation. In this manner, by providing the sensor unit on each of the functional switch units symmetrically arranged on the hub portion 21, it is possible to appropriately detect the contact or approach of a human body with respect to the recommended grip regions symmetrically arranged on the rim portion 22.

The above embodiments may be modified into various modes. Hereinafter, modified examples will be described. In the embodiment described above, the notification unit 113 is configured to generate the grip state information indicating the determination results of the water exposure determination unit 111 and the grip determination unit 112 as the determination units. However, the notification unit may include information other than the above determination results in the grip state information. For example, when the grip state information indicating “grip undeterminable” is generated in step S4, the notification unit may include, in the grip state information, information for identifying the water-exposed electrode. In addition, the grip state information may include instruction information (display information, audio information, or the like) that instructs an occupant to wipe off the water-exposed location. In addition, in the embodiment described above, when it is recognized that the driver is not gripping the steering wheel 2, the driving control unit 711 temporarily stops the driving assistance (steering assistance or the like), and when the non-grip state continues for a predetermined time, the driving control unit 711 cancels the driving assistance. However, the driving control unit may also temporarily stop or cancel the driving assistance on the basis of the grip state information output (transmitted) from the notification unit. For example, the driving control unit may temporarily stop or cancel the driving assistance according to the size of the water-exposed range or the duration of the water-exposed state when water exposure to the electrodes is recognized, on the basis of the grip state information. As a specific example, when the water-exposed range in the recommended grip regions HR and HL accounts for a proportion equal to or greater than a predetermined value of those regions, the driving assistance may be temporarily stopped or canceled. Furthermore, when the water-exposed state in the recommended grip regions HR and HL continues for a predetermined time or longer, the driving assistance may be temporarily stopped or canceled.

In addition, in the embodiment described above, the grip determination unit 112 as the determination unit calculates the moving average of the detection values (capacitance) of each electrode of the pair of electrodes, and compares the total value thereof with the determination threshold value C_Th to determine whether or not the steering wheel 2 is being gripped. However, the determination unit may be configured to execute the moving average when the variation in detection value of any of the electrodes SL1 to SL6 and SR1 to SR6 is equal to or greater than a predetermined level, more specifically, when the change amount of the detection values of any of the electrodes SL1 to SL6 and SR1 to SR6 for a predetermined time is equal to or greater than a predetermined level. That is, when the variation in detection value of all the electrodes SL1 to SL6 and SR1 to SR6 is less than a predetermined level, the determination unit may not execute the moving average (set the number of terms for the moving average to 1). Note that the determination unit may perform the above-described determination of whether to execute the moving average, using only the electrodes SL1 to SL3 and SR1 to SR3, which have large surface areas and are more susceptible to variations in detection values due to environmental changes. As a result, it is possible to appropriately switch between execution and stop of the moving average. In addition, in the embodiment described above, the grip determination unit 112 calculates the moving average of the detection values of each electrode of the pair of electrodes according to a predetermined number of terms on the basis of the surface area of each electrode of the pair of electrodes. However, the determination unit may change the number of terms for the moving average according to the magnitude of variation when the variation in the detection value of any of the electrodes SL1 to SL6 and SR1 to SR6 is equal to or greater than a predetermined level. Specifically, the larger the variation in detection value, the greater the number of terms for the moving average may be.

In addition, in the embodiment described above, when it is determined that the electrode of any grip sensor of the grip sensors 13L4 to 13L6 and 13R4 to 13R6 is exposed to water, that is, when the determination in step S3 in FIG. 6 is affirmative, the grip determination is not executed, and grip state information indicating “grip undeterminable” is generated. However, when the determination in step S3 in FIG. 6 is affirmative, the determination unit may determine whether or not the steering wheel 2 is being gripped on the basis of the detection value of the torque sensor 14. The notification unit may then generate the grip state information indicating the determination result. In this case, the notification unit may also include, in the grip state information, information indicating that the electrode is exposed to water and information for identifying the water-exposed electrode.

In addition, in the embodiment described above, the sensor units 13L and 13R detect the contact or approach of a human body with respect to the rim portion 22. However, the sensor unit may further detect a gripping force on the rim portion 22. In this case, a pressure sensor is embedded in the rim portion 22, and the sensor unit detects the gripping force on the steering wheel 2 on the basis of sensor values obtained from the pressure sensor via a signal line (not illustrated). The determination unit may determine whether or not the steering wheel 2 is being gripped on the basis of the magnitude of the gripping force detected by the pressure sensor, either together with the output values from the sensor units 13L and 13R, or in place of the output values from the sensor units 13L and 13R. Note that any sensor other than the pressure sensor may be used for detecting the gripping force on the steering wheel 2.

In addition, in the embodiment described above, the case where the controller 10 executes the processing in FIG. 6 while the subject vehicle is traveling has been given as an example. However, the controller 10 may start the processing in FIG. 6 when a notification indicating that the driving assistance function such as the LKAS is effective is received from the driving assistance apparatus 70. In addition, while the traveling speed of the subject vehicle is equal to or lower than a predetermined speed, the controller 10 may not execute the processing in FIG. 6. Furthermore, when a driving assistance function that does not require the driver to grip the steering wheel 2, such as an automatic parking function (parking assist system), is effective, the processing in FIG. 6 may not be executed.

In addition, in the embodiment described above, the irregularly shaped steering wheel is illustrated as the steering wheel 2, but the present invention is also applicable in a case where a steering wheel of another shape (circular or the like) is used. Furthermore, in the embodiment described above, the steering apparatus 50 is applied to the manually driven vehicle including the ADAS, but the steering apparatus 50 is also applicable to a self-driving vehicle.

The above embodiment can be combined as desired with one or more of the above modifications. The modifications can also be combined with one another.

According to the present invention, it is possible to improve robustness against an environmental change in the grip determination of the steering wheel.

Above, while the present invention has been described with reference to the preferred embodiments thereof, it will be understood, by those skilled in the art, that various changes and modifications may be made thereto without departing from the scope of the appended claims.

What is claimed is:

1. A steering apparatus comprising:
a sensor unit including a plurality of sensors configured to detect contact or proximity of a human body in a plurality of detection target regions provided on a steering wheel; and
a microprocessor, wherein
the microprocessor is configured to perform:
comparing output values of the sensor unit with a determination threshold value; and
determining whether or not the steering wheel is being gripped, based on a result of the comparing, wherein
the plurality of sensors include a plurality of electrodes,
the plurality of electrodes include a pair of electrodes arranged such that the detection target regions thereof overlap each other and have different surface areas, and wherein
the microprocessor is configured to perform
the determining including calculating a moving average of a detection value of each of the pair of electrodes according to a predetermined number of terms for each of the pair of electrodes, and further comparing a total value of the moving averages of the pair of electrodes with the determination threshold value as the output value of the sensor unit.

2. The steering apparatus according to claim 1, wherein
the microprocessor is configured to perform
the determining including calculating the moving average of the detection value of each of the pair of electrodes according to a number of terms predetermined based on the surface area of each of the pair of electrodes.

3. The steering apparatus according to claim 2, wherein
the microprocessor is configured to perform
the determining including determining the number of terms of the moving average of each of the pair of electrodes such that the larger the surface area, the greater the number of terms of the moving average.

4. The steering apparatus according to claim 3, wherein
the microprocessor is configured to perform
the determining including, when a change amount of the detection value of either of the pair of electrodes for a predetermined time is equal to or greater than a predetermined amount, increasing the number of terms of the moving average of each of the pair of electrodes as the change amount increases.

5. The steering apparatus according to claim 1, wherein
the microprocessor is configured to perform
the determining including, when the change amounts of the detection values of both of the pair of electrodes for a predetermined time are less than a predetermined amount, setting the number of terms of the moving average of each of the pair of electrodes to 1.

6. The steering apparatus according to claim 1, wherein
the plurality of electrodes include a plurality of pairs of electrodes having different detection target regions, and wherein
the microprocessor is configured to perform
the determining including calculating the total value of the moving averages for each pair of electrodes, and determining that the steering wheel is being gripped when the total value of the moving averages of any one of the plurality of pairs of electrodes is equal to or greater than the determination threshold value.

7. The steering apparatus according to claim 1, wherein
the pair of electrodes includes a first electrode and a second electrode having a smaller surface area than the first electrode, and
the first electrode and the second electrode are arranged adjacent to each other such that distances from a grip portion of the steering wheel are substantially the same.

8. The steering apparatus according to claim 7, wherein
the microprocessor is configured to perform
the determining including, when the detection value of the second electrode having the smaller surface area among the pair of electrodes is equal to or greater than a predetermined value, determining that the second electrode or the pair of electrodes is exposed to water.

9. The steering apparatus according to claim 1, further comprising
an output device configured to output information, wherein
the microprocessor is further configured to perform notifying a driver, via the output device, of information generated based on a result of the determining.

10. The steering apparatus according to claim 1, wherein
the steering apparatus includes a plurality of the sensor units, wherein
the steering wheel includes: a hub portion; a grip portion having a pair of left and right vertical portions extending substantially in an up-down direction on left and right sides of the hub portion and a horizontal portion extending substantially in a left-right direction below the hub portion and connecting the pair of left and right vertical portions; and spoke portions connecting the pair of left and right vertical portions to the hub portion, and wherein
the plurality of sensor units are arranged in the vicinity of functional switch units respectively provided on left and right portions of the hub portion for vehicle information operation or driving assistance function operation.
